(19) United States
(12) Patent Application Publication
(10) Pub. No.: US 2011/0033710 A1
(43) Pub. Date: Feb. 10, 2011

(54) COMPOSITE STRUCTURES OF A METAL COMPONENT WITH A RESIN COMPONENT AND ARTICLES THEREOF

(75) Inventor: Tsunao Kenmochi, Aichi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/842,301

(22) Filed: Jul. 23, 2010

Related U.S. Application Data
(60) Provisional application No. 61/228,168, filed on Jul. 24, 2009.

(51) Int. Cl. B32B 7/04; B32B 15/04; B32B 27/06

(52) U.S. Cl. 428/416; 428/447; 428/429

(57) ABSTRACT

The present invention aims at providing an article having a composite structure including a metal component and a resin component bonded together. The present invention provides an article which is a composite structure, including a first component and s second component, the first component is a metal substrate and the second component is a molded product comprising a thermoplastic resin composition, and the reaction of a silane coupling compound resin with the metal substrate for forming binder between the first and second components comprising SiOx, C—Si—O—X bond (X is metallic substance of the first component) as determined by x-ray photoelectron spectroscopy, wherein the bonding strength between the first and second components is about 30 Mpa or more.

### CROSS REFERENCE TO RELATED APPLICATIONS

This application claims the benefit of U.S. Provisional Application No. 61/228,168, filed Jul. 24, 2009, which is incorporated herein by reference in its entirety.

### FIELD OF THE INVENTION

The present invention relates to composite structures comprising a metal component and a resin component bonded together. More particularly, the present invention relates to an article containing a composite structure that can be constituted of the metal component and resin component suitably bonded together.

### BACKGROUND OF THE INVENTION

In fields such as automobiles, electronic devices, industrial machinery and the like it is common to use components comprising either a metal component or a resin component. That is, metal components or resin components are manufactured and are then ordinarily assembled together.

In recent years, by contrast, a composite structure in which a metal component and a resin component are bonded together have attracted attention as a means for coping with a wide variety of characteristic requirements as well as in terms of, for instance, weight reduction and cost reduction.

Methods for bonding the metal component and the resin component are broadly divided into physical bonding and chemical bonding. Physical bonding refers to bonding between components affected by means of irregularities and mating portions formed on the metal component and the resin component. Packing is often sandwiched between the metal and the resin component in order to secure adherence.

In chemical bonding, the metal component and the resin component are bonded by way of interactions between the components. The most ordinary chemical bonding method involves using an adhesive agent. For instance, hot melt adhesives and epoxy thermosetting resins are often used. However hot melt adhesives generally have poor thermal stability and epoxy and other thermosetting resins require long set times to establish the maximum adhesive bond. Other known methods involve irradiating laser light onto the bonding portion, to fuse the bonding portion and elicit bonding through compression bonding, or methods that involve providing a layer comprising a thermoplastic resin or a thermosetting resin between components of dissimilar materials, and then elicit bonding via such a resin layer through heating and application of pressure. Also known in the prior art are the below-described insert molding methods.

Chemical bonding, according to the present invention, would require forming chemical bonds at the interface between the metal component and resin component in order to produce adhesion.

Japanese Unexamined Patent Application Laid-open No. 2006-315398 describes a method for obtaining a metal-resin composite member by insert injection molding in which a metal member is inserted into a mold and a resin composition is injected, to be bonded with the metal member. Such a method for obtaining a metal-resin composite member comprises, specifically, inserting into an injection mold an aluminum-alloy shaped article having been immersed in an aqueous solution selected from among ammonia, hydrazine and a water-soluble amine compound, and injecting a polyamide resin to elicit bonding with the aluminum-alloy shaped article.

Japanese Unexamined Patent Application Laid-open No. 2007-50630 also describes a method for obtaining a metal-resin composite member by insert injection molding. Specifically disclosed is a composite member comprising a metal member the entire surface whereof is covered by recesses having an average inner diameter no greater than 80 nm, and a resin component comprising 70 to 99 wt % of polyphenylene sulfide and 1 to 30 wt % of a polyolefin resin.

JP Patent No. 2,878,967 (Nakagawa, et al.) discloses a method to strengthen adhesion between resin and metal in metal-insert molding process comprising pretreating the metal surface with an alkoxysilane compound. JP laid open patent No. 2004-346255 discloses a polyamide composition containing a silane coupling agent and an epoxy-modified styrene elastomer to strengthen adhesion with metal.

However, the disclosures of the references are concerned with silane coupling agent. None of them addresses formation of chemical bond on surface of a substrate with the agent and suggest more effective and improved bonding in application using metal-resin composite structure. This technique is, in particular highly required for automotive parts application.

Commercialization of a composite article comprising a metal component and a resin component at which interface the so-called chemical bonds are formed, however, has been hindered by several significant technical hurdles. For example, a commercially practical article, among other requirements, must have adequate adhesion between the components, or what is known in the art as mechanical properties in applications such as automotive parts. Additionally, a commercially practical composite article must be easily manufactured.

Additional problems are caused by many localities that have regulations requiring the use of low VOC (volatile organic content) adhesion compositions for chemical bonding to reduce air pollution caused by organic solvent emissions

It is an object of the present invention to provide an article comprising a composite structure comprising a metal component and a resin component having enhanced interface adhesion, making them suitable for use in a variety of applications.

### SUMMARY OF THE INVENTION

Disclosed and claimed herein is a composite structure comprising:
a) a first component comprising a metal substrate;
b) a second component comprising a thermoplastic resin composition; and
c) a silane coupling compound applied to said metal substrate of said first component, to form a binder between said first component and said second component, said binder comprising a SiOx, C—Si—O—X bond (wherein X is the metallic substance of said metal substrate of said first component) as determined by x-ray photoelectron spectroscopy, wherein the ratio of the SiOx, C—Si—O—X bond strength and the metal bond strength is over 0.08, and further wherein the bonding strength between said first component and said second component is greater than or equal to about 30 Mpa.

There is also disclosed and claimed herein articles formed from the composite structures of the present invention.

### BRIEF DESCRIPTION OF THE DRAWINGS

FIG. 1 is a schematic cross-sectional view of a composite article according to the present invention.

FIGS. 2A and 2B illustrate the formation of the composite structure, and the procedure for measuring bonding strength of the metal-resin composite structure.

### DETAILED DESCRIPTION OF THE INVENTION

The metal component employed in the metal-resin composite structure of the present invention is not particularly limited provided that it is a metal or a metal alloy. Examples thereof include, for instance, steel, nickel, chromium, copper, zinc, titanium, aluminum, magnesium or the like, or metal alloys of the foregoing. Preferably, the metal component is selected from the group consisting of aluminum, aluminum alloy, iron and iron alloy and copper and copper alloy. Preferably, also, at least one of the surfaces of the metal component is formed of aluminum, aluminum alloy, iron or iron alloy.

The present invention is directed to a composite structure bonded by a binder defined by surface atomic composition to be measured by X-ray photoelectron spectroscopy (XPS) and bonding strength, and which is used to determine the oxidation state of metal atoms and the bond formed of C—Si—O—X. The binder (e.g., a silane coupling compound applied to a metal substrate) includes the formation of a bond which is commonly found when metal atoms coordinate with non-metals or other metallic atoms or groups, the formation being also detected by using XPS (which involves the irradiation of a sample with soft X-rays, and the energy analysis of photoemitted electrons that are generated close to the substrate surface, which has the ability to detect all elements (with the exception of hydrogen and helium) in a quantitative manner, but which is also used to probe the chemical state of element through the concept of binding energy shift).

In a preferred embodiment, a resin component is made of thermoplastics. More preferred thermoplastic resins are semi crystalline resins, and most preferred are semi crystalline resins which have functional groups of amid bond and/or ester bond.

Examples of thermoplastic resins useful as resins for the resin component, for instance, include polyamides (PA) polyethylene (PE), polypropylene (PP), styrene-acrylonitrile copolymers, polyesters, polyphenylene sulfide (PPS), modified polyphenylene ether (PPE) and the like.

Preferably the thermoplastic resins are selected from the group consisting of polyamides including polyamide 6, polyamide 6,6, polyamide 6,10, polyamide 6,12, polyamide 66,6T, polyamide 6T,DT, and blends thereof; polyesters (including poly(ethylene) terephthalate (PET), poly(trimethylene) terephthalate (PTT); poly(butylene) terephthalate) (PBT) and blends thereof; copolyetheramide elastomers and blends thereof; and copolyetherester elastomers and blends thereof.

The polybutylene terephthalate (PBT) resin may be a homopolymer obtained by condensation polymerization of terephthalic acid and butanediol, but may also be copolymer containing other comonomer components that share the physical and chemical characteristics of polybutylene terephthalate resins. Examples of these other comonomer components include, for instance, glycol components such as ethylene glycol, 1,2-polypropylene glycol, pentanediol, hexanediol, 1,4-cyclohexanedimethanol or the like, or dicarboxylic acid components such as isophthalic acid, naphthalene dicarboxylic acid or the like. Specific examples of the above copolymers include, for instance, (poly)butylene-coethylene-terephthalate, (poly)butylene-co-1,4-cyclohexanedimethylene-terephthalate, (poly)butylene-copentylene-terephthalate, (poly)butylene-cohexylene-terephthalate, (poly)butylene-terephthalate-isophthalate, (poly)butylene-terephthalate-naphthalene dicarboxylate and the like. The polybutylene terephthalate resin used in the present invention is preferably a polybutylene terephthalate resin having an intrinsic viscosity of at least about 0.4 when measured in a 0.1% m-cresol solution at 30° C., more preferably a polybutylene terephthalate resin having an intrinsic viscosity of up to about 1.2.

The copolyetheramide elastomer useful in this invention is an elastomer comprising a polymeric hard segment (X) which is a poly(aminocarboxylic acid) or poly(lactam) having 6 or more carbon atoms or a nylon m,n polymer in which m+n is 12 or more and a polymeric soft segment (Y) which is a polyol, preferably, a poly(alkylene oxide)glycol, wherein the proportion of the (X) component is 10-95% by weight, preferably 20-90% by weight.

The polymeric hard (X) segment of the poly(aminocarboxylic acids) may be chosen from ω-aminocaproic acid, ω-aminoenanthic acid, ω-aminocaprylic acid, ω-aminopelargonic acid, ω-aminocapric acid, 11-aminoundecanoic acid, 12-aminododecanoic acid and the like. Likewise the polylactams may be chosen from caprolactam, laurolactam and the like. The nylon may be chosen from nylon 6,6, nylon 6,10, nylon 6,12, nylon 11,6, nylon 11,10, nylon 12,6, nylon 11,12, nylon 12,10, nylon 12,12 and the like.

The (Y) segment, is one or more poly(alkylene oxide)glycols, as described above, and include poly(ethylene oxide)glycol, poly(1,2- or 1,3-propylene oxide)glycol, poy(tetramethylene oxide)glycol, poly(hexamethylene oxide)glycol, an ethylene oxide-proplene oxide block or random copolymer, an ethylene oxide-tetrahydrofuran block or random copolymer, etc. Of these poly(alkylene oxide)glycols (Y), poly(ethylene oxide)glycol is particularly preferable because of its compatibility with polyoxymethylene. The number-average molecular weight of the poly(alkylene oxide)glycol (Y) is preferably 200-6,000, more preferably 250-4,000.

The terminals of the poly(alkylene oxide)glycol (Y) may be aminated or carboxylated. As the bond between the (X) component and the (Y) component, an ester bond or an amide bond is possible depending upon the terminal groups of the polyamide elastomer. In bonding the (X) component to the (Y) component, a third component (Z) such as a dicarboxylic acid, a diamine or the like can be used.

The dicarboxylic acid is chosen having 4-20 carbon atoms and includes, for example, aromatic dicarboxylic acids such as terephthalic acid, isophthalic acid, naphthalene-2,6-dicarboxylic acid, naphthalene-2,7-dicarboxylic acid, diphenyl-4,4-dicarboxylic acid, diphenoxyethanedicarboxylic acid, sodium 3-sulfoisophthalate and the like; alicyclic dicarboxylic acids such as 1,4-cyclohexanedicarboxylic acid, 1,2-cyclohexanedicarboxylic acid, dicyclohexyl-4,4-dicarboxylic acid and the like; aliphatic dicarboxylic acids such as succinic acid, oxalic acid, adipic acid, sebacic acid, dodecanedicarboxylic acid and the like; and their mixtures. Of these, terephthalic acid, isophthalic acid, 1,4-cyclohexanedicarboxylic acid, sebacic acid, adipic acid and dodecanedicarboxylic acid are particularly preferable in view of polymerizability, color and physical properties.

The diamine includes aromatic, alicyclic and aliphatic diamines. An example of the aliphatic diamines is hexamethylenediamine.

The copolyetherester elastomers useful in the invention are such as is disclosed in U.S. Pat. No. 3,766,146, U.S. Pat. No. 4,014,624 and U.S. Pat. No. 4,725,481. These patents disclose a segmented thermoplastic copolyetherester elastomer containing recurring polymeric long chain ester units derived from carboxylic acids and long chain glycols and short chain ester units derived from dicarboxylic acids and low molecular weight diols. The long chain ester units form the soft segment of the copolyetherester elastomer, and the short chain ester units form the hard segment.

More specifically, such copolyetherester elastomers may comprise a multiplicity of recurring intralinear long chain and short chain ester units connected head-to-tail through ester linkages, said long chain ester units being represented by the formula:

—OGO—C(O)RC(O)— (I)

and said short-chain ester units being represented by the formula:

—ODO—C(O)RC(O)— (II)

wherein:
G is a divalent radical remaining after removal of terminal hydroxyl groups from poly(alkylene oxide) glycols, as disclosed above, having a carbon to oxygen ratio of about 2.0-4.3, a molecular weight above about 400 and a melting point below about 60° C.;
R is a divalent radical remaining after removal of carboxyl groups from a dicarboxylic acid having a molecular weight less than about 300; and
D is a divalent radical remaining after removal of hydroxyl groups from a low molecular weight diol having a molecular weight less than about 250.

It is preferred that the short chain ester units constitute about 15-95% by weight of the copolyester and at least about 50% of the short chain ester units be identical.

The term “long chain ester units” as applied to units in a polymer chain refers to the reaction product of long chain glycol with a dicarboxylic acid. Such “long chain ester units”, which are a repeating unit in the copolyesters, correspond to the formula (I) above. The long chain glycols are polymeric glycols having terminal (or as nearly terminal as possible) hydroxyl groups and a molecular weight above about 400 and preferably from about 400-4000. The long chain glycols used to prepare the copolyesters are poly(alkylene oxide) glycols as disclosed above.

The term “short chain ester units” as applied to units in a polymer chain refers to low molecular weight compounds or polymer chain units having molecular weights less than about 550. They are made by reacting a low molecular weight diol (having a molecular weight below about 250) with a dicarboxylic acid to form ester units represented by formula (II) above.

Included among the low molecular weight diols which react to form short chain ester units are acyclic, alicyclic and aromatic dihydroxyl compounds, an example of which is 1,4-butanediol. Dicarboxylic acids which are reacted with the foregoing long chain glycols and low molecular weight diols to produce the copolyesters of this invention are aliphatic, cycloaliphatic or aromatic dicarboxylic acids of low molecular weight, that is, having a molecular weight of less than about 300, an example of which is terephthalic acid.

The composite structure of the present invention can comprise on its surface of either component, an adhesive compound. the adhesive compound can be a silane coupling compound, as described further hereinbelow. Preferably the coupling compound is selected from every types of silane coupling agent which contain either or both of amino- or epoxy-functional end group. For example, Aminopropyltriethoxysilane H2C3H6-Si(OC2H5)3 (trade name of Z-6011 of Dow Silane), Aminoethylaminopropyltrimethoxysilane H2C2H4NHC3H6-Si(OCH3)3; Vinylbenzylaminoethylaminopropyltrimethoxy silane (H2C═CH—C6H4-CH2-NHC2H4NHC3H6-Si(OCH3)3); as amino end group and Glycidoxypropyltrimethoxysilane CH2(O)CHCH2OC3H6-Si(OCH3)3 (trade name of Z-6040 of Dow Silane), Glycidoxypropylmethyldiethoxysilane CH2(O)CHCH2-OC3H6-Si(CH3)(OC2H5)2 as epoxy silane.

The silane coupling agents or compound may be applied through solution, emulsion, dispersion, and the like, coating processes. For example, solution of mixture of silane coupling agent and water diluted by alcohol is used for disposing the silane coupling agent on its surface of the metal component. And in order to control amount of coupling agent applied on the metal surface, it is typically applied by disposing the solution onto the metal component surface, using conventional means, such as spray. One of ordinary skill in the art will be able to identify appropriate process parameters based on the composite structure article and process used for the bonding. The process conditions and parameters for making bonding by any method in the art are easily determined by a skilled person for any given article and desired application. For example, the silane solution is ordinarily applied to the metal surface layer diluted in water/alcohol (for instance, methanol, ethanol or the like), and the silane content is adjusted to be less than 20 volume percent in the mixture with water and alcohol. Preferably, the silane content in the solution is less than 5 percent diluted by water or mixed with the same amount of water diluted by alcohol. The alcohol is used to minimize drying time on the metal. Thickness of the adhesive layer can be measured by X-ray photoelectron spectroscopy (XPS) and the thickness effective for this invention is from 1 nm to 10 nm. Preferably, as the bonding strength between the metal component and the resin component is compared to the thickness of the adhesive layer, excess more than 2 nm is recommended to get maximum bonding strength. Thicknesses of the adhesive layer over 10 nm can not be measured by XPS and excessive thicknesses do not establish high bonding strength.

SiOx, C—Si—O—X bond (X is metallic substance of the first component; SiOx is a common abbreviation for silicon oxide) bond formed at the interface between the metal component and the resin component of the composite structure of the present invention exhibits the improved bonding strength. And bonding strength by applying this silane solution can be expected by mol ratio between metal and SiOx, C—Si—O—X bond (X is metallic substance of the first component) by measuring XPS.
In one embodiment the composite structured article has an adhesive strength between said metal component and said resin component of greater than 30 Mpa; as measured by following procedure. This procedure use same testing machine which are used in ISO 527 procedure except holding device.

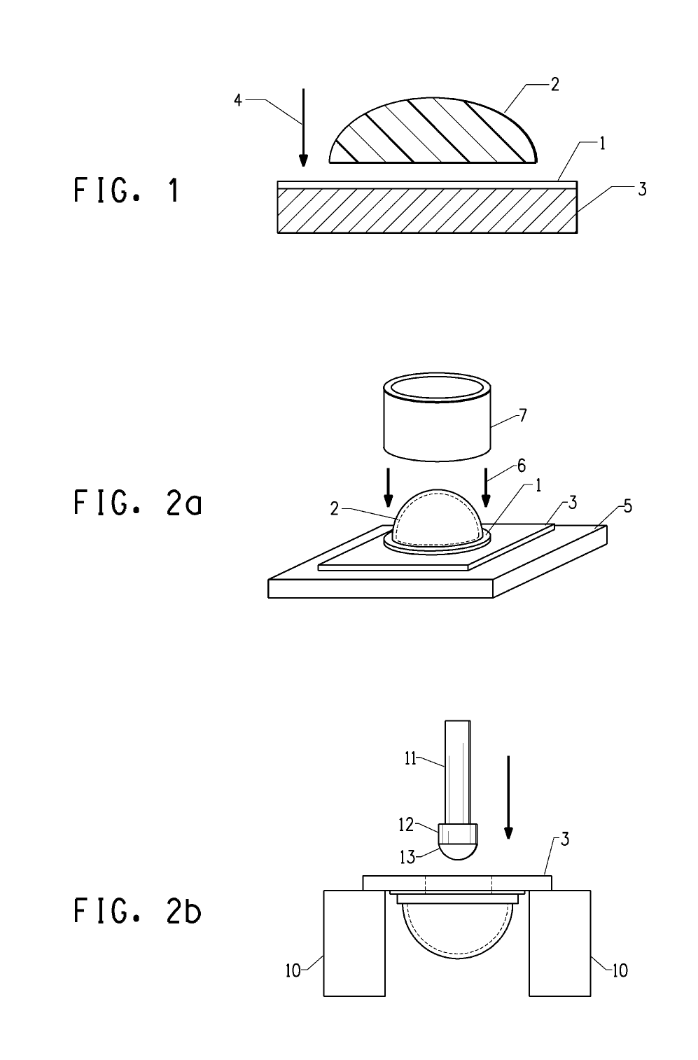

FIG. 1 is a schematic cross-sectional view of a composite structured article according to the present invention. The silane coupling agent layer (1) is sandwiched between the metal component (3) and the resin component (2). Typically there will be at least some pressure (4) during bonding so that the resin component (2) is forced against the metal component (3).

The silane coupling agent adhesion layer 1 forms SiOx, C—Si—O—X bond (X is metallic substance of the first component) bond formed at the interface between the metal component and the resin component of the composite structure, which is not shown in FIG. 1. The silane coupling agent adhesion layer 1 is, in terms of bonding strength, preferably comprised of particularly preferred silane coupling agent here Aminopropyltriethoxysilane H₂C₃H₆—Si(OC₂H₅)₃ and Glycidoxypropyltrimethoxysilane CH₂(O)CHCH₂OC₃H₆—Si(OCH₃)₃ as commercially available from Dow Chemical Co. under the trade name Z-6011 and Z-6040 Silanes, respectively,

Process for Making Composite Structure

While not intended to be limiting, one method of making the composite structure of this invention is by arranging at least one surface of a metal component, applying a silane solution using the correct procedure to achieve good bonding strength so as to oppose at least one surface of a resin component comprising a thermoplastic resin. After combining the two components together, bonding can be accomplished by any conventional fusion method at least directed to some of the contact area.

Examples of suitable processes include, for instance, fusion by hot-plate heating, fusion by high-frequency induction heating, laser fusion, injection fusion, ultrasound fusion, vibration fusion, spin fusion and the like. Preferred fusion methods include fusion by hot-plate heating, fusion by high-frequency induction heating and laser fusion. In laser fusion, preferably, a laser absorbent is placed on the surface of the metal component, in contact with the resin component. Examples of the laser absorbent include, for instance, carbon black and coloring materials such as dyes and pigments, preferably carbon black. Expected applications from this technology cover many of automotive devices, because such devices require a balance of weight and performance. Limited metal areas when deployed can minimize the weight of the device. Engine supporting devices and ECU (engine control unit) are examples of the expected applications in automotive devices.

### Examples

### Method for Molding the Resin Component

A resin component (2) having a domed top (36 mm diameter) and 2 mm flange at the bottom (total diameter of the bottom is 40 mm) and illustrated in FIG. 1; was prepared by a polyamide 6,6 resin (Zytel® 70G33HS1L NC010, from E.I. du Pont de Nemours and Company, Wilmington, Del.) reinforced with 33% glass fibers, and by injection-molding of the resin, with a water content not exceeding 0.2%, using a universal injection molding machine (α100iA, by Fanuc), at a resin temperature of 290° C. and a mold temperature of 90° C.

A second resin component (2) having the shape as described above, was similarly prepared by a PBT resin (Crastin® SK605 NC010, from E.I. du Pont de Nemours and Company, Wilmington, Del.) reinforced with 30% glass fibers, and by injection-molding the resin, with a water content not exceeding 0.05%, using a universal injection molding machine (α100iA, by Fanuc), at a resin temperature of 260° C. and a mold temperature of 80° C.

Method for Surface Treating the Metal Plate with Silane Solution

A silane coupling agent stock solution (Z6011, from Toray Dow Corning Co., Ltd.) was sprayed onto the surface of the metal by spray unit (commercially available from Fuso Seiki), for instance, for 0.5 seconds. The stock solution was prepared having a weight ratio of ethanol/water/Z6011 based on a total weight of composition being 90/5/5 or 99.9/0.05/0.05.

Method for Forming the Metal-Resin Composite Component

After preparing two components of the surface treated metal and resin, two each components is adhered each other by heating metal component.

A metal plate (50 mm×50 mm×3 mmT with 25 mm hole in the center portion which was provided for insertion of a stress-exerting jig for measurement of bonding strength) was placed on a heater plate by facing the side surface treated with silane solution to opposite side from heater. The resin part is placed on the metal by contacting resin and surface treated metal side with each other. Press area is flange of the resin cap by metal ring (internal diameter is 36 mm and external diameter is 40 mm) illustrated. For example, in case of polyamide and metal bonding, heater is preheated to 250 C (10 C lower than melt temperature). And immediately after putting the components increase temperature from 250 C to 263 C gradually. Immediately after temperature reached to set temperature, press the metal ring by air cylinder. At the same time, remove heating and temperature is gradually decreasing along with thermal diffusion to air. And temperature reduced to 250 C, the composite structure is removed from the heater system. Finally, immediately after temperature of the composite article reached less than 50 C, they are packed in to moisture proof packing.

As illustrated in FIG. 1, the metal component (3), and the resin component (2) were stacked vertically, in the bonding disposition, on a plate heater (5) (not shown in FIG. 1, but FIG. 2(a)) residually heated beforehand to 20° C. lower than the melting point of the resin. FIG. 2(a) illustrates the formation of a metal composite (1). The heater (5) was heated next, to a temperature 5° C. higher than the melting point of the resin. The heater (5) was turned off when the temperature reached a temperature 5° C. higher than the melting point of the resin cap, and then a load (6) (0.1 to 0.5 MPa) was applied using a steel tubular thrust ring (7) (outer diameter 40 mm, inner diameter 36 mm, height 22 mm). The assembly was left to stand, and was cooled to a temperature about 20° C. lower than the melting point of the resin.

Method for Measuring Bonding Strength

The bonding strength of the metal-resin composite structured article prepared as described above was measured after leaving it 48 hours at 23° C. in a test room having adjustable atmosphere temperature keeping it within a moisture proof package. FIG. 2(b) illustrates the Method for Measuring Bonding Strength of the metal-resin composite members. The outer periphery of the flange portion of the metal member (3) of the metal composite member (1) was mounted on the universal tester mount (10) (Autograph, by Shimadzu), without pinching the resin member. Then a metal rod (11) having a 5 mm thick circular end plate (12) and a 16 mm diameter metal semisphere (13) mounted on the end plate was inserted into the hole of the metal member, contacting and exerting pressure against the central portion of the resin member. The strength upon partial breakage of the bonding portion was then measured. Under these test conditions all samples had a uniform bonding area of 452.1 mm².

The outer periphery of the flange portion of the metal component 3 was fixed to a universal tester 10 (Autograph, by Shimadzu), without pinching the resin component, then a metal rod 11 having a 5 mm thick circular end plate 12 and a semispherical top end 13 mounted on the end plate was inserted into the hole of the metal component, exerting pressure against the central portion of the resin component. The strength upon partial breakage of the bonding portion was then measured. Results of the bonding strength of the bond of the metal-resin composite structured article are presented in Table 1.

As presented in Table 1, ratio of SiOx, C—Si—O—Al bond strength against Al strength measured by XPS which is the analytical technique often used to identify near surface functional groups and to provide semiquantitative near surface elemental and ionic composition—spectra characterizing the near surface chemistry of the samples composed of Al substrate before and after silane treatment was processed, SiOx, C—Si—O—Al bond was revealed by the appearance of binding energy peaks for individual identified element, which illustrates SiOx, C—Si—O—Al bond formed on AL substrate and comparison of the binding energy peaks on different pretreatment samples provides the ratio, is correlated with mechanical bonding strength. Comp A and B are comparative examples with lower ratio of SiOx, C—Si—O—Al bond, Examples 1 to 3 are a composite structure according to the invention. Increasing SiOx, C—Si—O—Al bond results increasing of bonding strength. Considering actual application, minimum strength is most important data. In order to achieve minimum bonding strength of 30 MPa, minimum SiOx, C—Si—O—Al bond strength against Al strength measured by XPS is more than 0.08. Various polymers were prepared in a similar manner to Examples in Table 1 to see synergy with silane coupling agent. The results are summarized in Table 2. Table 2 reports that PBT and polyamide achieved improved bonding strength of 30 MPa in combination with selected silane coupling compared with the comparative examples Comp C and D using POM. As reference, Z6011 is Glycidoxypropyltrimethoxysilane CH₂(O)CHCH₂OC₃H₆—Si(OCH₃)₃ available from Dow Chemical. Various metals were prepared in a similar manner to Examples in Table 1 to see synergy with silane coupling agent. The results are summarized in Table 3. Iron (S45C) achieves similar bonding strength to Aluminum. As shown in Example 13, a combination of Copper with epoxysilane (Z6040) provides excellent bonding strength. SiOx, C—Si—O—X bond (X is metallic substance of the metal component) is obtained by the same procedure as in Examples in Table 1.

TABLE 1
Correlation between SiOx, C—Si—O—Al bond to bonding strength

| | | Examples | | | | |
|---|---|---|---|---|---|---|
| | | Comp A | Comp B | 1 | 2 | 3 |
| Resin | | PA66-G33 | PA66-G33 | PA66-G33 | PA66-G33 | PA66-G33 |
| Metal | | Aluminum | Aluminum | Aluminum | Aluminum | Aluminum |
| | | A1050 | A1050 | A1050 | A1050 | A1050 |
| Silane coupling | | Z6011 | Z6011 | Z6011 | Z6011 | Z6011 |
| Spray time second | | 0 | 0.1 | 0.2 | 0.5 | 0.5* |
| ratio of SiOx, | | 0.02 | 0.03 | 3.8 | 4.3 | 0.08 |
| C—Si—O—Al | | | | | | |
| and Al bond | | | | | | |
| Bonding | N = 1 | 19.8 | 27.0 | 47.2 | 48.1 | 46.0 |
| strength Mpa | 2 | 16.4 | 31.9 | 49.7 | 48.1 | 37.4 |
| | 3 | 29.7 | 33.2 | 45.4 | 48.4 | 44.9 |
| | 4 | 30.5 | E | E | 48.0 | E |
| | 5 | 8.4 | E | E | 45.7 | E |
| | 6 | 11.9 | E | E | 47.9 | E |
| | 7 | 27.8 | E | E | E | E |
| | 8 | 8.5 | E | E | E | E |
| | 9 | 10.1 | E | E | E | E |
| | average | 18.1 | 30.7 | 47.4 | 47.7 | 42.8 |
| | max. | 30.5 | 33.2 | 49.7 | 48.4 | 46.0 |
| | min. | 8.4 | 27.0 | 45.4 | 45.7 | 37.4 |

“E” means that the measurement (at N being less number)permits a estimate of the bonding strength at N being larger numbers.

TABLE 2
Effect of Base Polymer and type of
Silane

| | | Example | | | | | |
|---|---|---|---|---|---|---|---|
| | | 4 | 5 | 6 | 7 | Comp C | Comp D |
| Resin type | | PA66-G33 | | PBT-G30 | | POM-G25 | |
| Metal | | Aluminum | | Aluminum | | Aluminum | |
| | | A1050 | | A1050 | | A1050 | |
| Silane type | | Z6011 | Z6040* | Z6011 | Z6040* | Z6011 | Z6040* |
| Bonding | N = 1 | 49.3 | 49.5 | 14.9 | 32.4 | 1.8 | 0.0 |
| strength | 2 | 51.1 | 49.6 | 15.1 | 33.9 | 0.6 | 0.0 |
| Mpa | 3 | 50.8 | 50.2 | 17.4 | 30.0 | 0.7 | 0.0 |
| | 4 | 48.1 | E | E | E | E | E |
| | 5 | 48.1 | E | E | E | E | E |
| | 6 | 48.4 | E | E | E | E | E |
| | average | 49.3 | 49.8 | 15.8 | 32.1 | 1.0 | 0.0 |
| | max. | 51.1 | 50.2 | 17.4 | 33.9 | 1.8 | 0.0 |
| | min. | 48.1 | 49.5 | 14.9 | 30.0 | 0.6 | 0.0 |

*mixed Z6011 partially to enhance chemical reaction

TABLE 3
Effect of type of metal and type of Silane

| | | Trial combination | | | | | |
|---|---|---|---|---|---|---|---|
| | | Example 8 | Example 9 | Example 10 | Example 11 | Example 12 | Example 13 |
| Resin | | PA66-G33 | PA66-G33 | PA66-G33 | PA66-G33 | PA66-G33 | PA66-G33 |
| Metal type | | Aluminum | | Iron | | Copper | |
| | | (A1050) | | (S45C) | | (C1100) | |
| Silane type | | Z6011 | Z6040* | Z6011 | Z6040* | Z6011 | Z6040* |
| Bonding | N = 1 | 49.3 | 49.5 | 47.0 | 44.7 | 19.3 | 44.0 |
| strength | 2 | 51.1 | 49.6 | 47.2 | 46.2 | 16.0 | 37.6 |
| Mpa | 3 | 50.8 | 50.2 | 42.9 | 43.5 | 19.4 | 43.9 |
| | 4 | 48.1 | E | E | E | 16.0 | E |
| | 5 | 48.1 | E | E | E | 35.2 | E |
| | 6 | 48.4 | E | E | E | 17.7 | E |
| | average | 49.3 | 49.8 | 45.7 | 44.8 | 20.6 | 41.8 |
| | max. | 51.1 | 50.2 | 47.2 | 46.2 | 35.2 | 44.0 |
| | min. | 48.1 | 49.5 | 42.9 | 43.5 | 16.0 | 37.6 |

note:
*mixed Z6011 partially to enhence chemical reaction

1. A composite structure comprising:
a) a first component comprising a metal substrate;
b) a second component comprising a thermoplastic resin composition; and
c) a silane coupling compound applied to said metal substrate of said first component, to form a binder between said first component and said second component, said binder comprising a SiOx, C—Si—O—X bond (wherein X is the metallic substance of said metal substrate of said first component) as determined by x-ray photoelectron spectroscopy, wherein the ratio of the SiOx, C—Si—O—X bond strength and the metal bond strength is over 0.08, and further wherein the bonding strength between said first component and said second component is greater than or equal to about 30 Mpa.

2. The composite structure of claim 1 wherein said first component is aluminum and said second component is made of polyamide.

3. The composite structure of claim 1 wherein said metal substrate is selected from the group consisting of aluminum, aluminum alloy, iron, iron alloy, copper, and copper alloy.

4. The composite structure of claim 1 wherein said thermoplastic resin composition of said second component are either or both of polyamide or polyester.

5. The composite structure of claim 1 wherein said thermoplastic resin composition of said second component is glass reinforced product.

6. The composite structure of claim 1 wherein said silane coupling compound is selected from the group consisting of aminosilane and epoxysilane.

7. The composite structure of claim 1 in the form of an article.
